(19) United States
(12) Patent Application Publication
(10) Pub. No.: US 2021/0170889 A1
(43) Pub. Date: Jun. 10, 2021

(54) MOTOR VEHICLE CHARGING

(71) Applicant: Panasonic Automotive Systems Company Of America, Division of Panasonic Corporation of North America, Peachtree City, GA (US)

(72) Inventors: PADHU KANAGARAJ, FARMINGTON HILLS, MI (US); GARRETT LASKOWSKI, LINDEN, MI (US)

(73) Assignee: Panasonic Automotive Systems Company Of America, Division of Panasonic Corporation of North America

(21) Appl. No.: 17/116,258

(22) Filed: Dec. 9, 2020

Related U.S. Application Data
(60) Provisional application No. 62/945,976, filed on Dec. 10, 2019.

(51) Int. Cl. B60L 53/122; H02J 7/04; H02J 50/10; H02J 50/80; H02J 7/00; G06Q 20/32; B60L 58/12; B60L 50/60; B60L 53/126; B60L 53/66

(52) U.S. Cl. CPC B60L 53/122; H02J 7/04; H02J 50/10; H02J 50/80; B60L 53/665; G06Q 20/322; B60L 58/12; B60L 50/60; B60L 53/126; H02J 7/00032

(57) ABSTRACT

An arrangement for charging a battery in a first motor vehicle includes a wireless charger receiver electrically coupled to the battery. The wireless charger receiver wirelessly receives electrical energy from a second motor vehicle and stores the received electrical energy in the battery. A battery management system is electrically connected to the wireless charger receiver and to the battery. The battery management system controls transfer of the electrical energy from the wireless charger receiver to the battery.

### CROSS-REFERENCED TO RELATED APPLICATIONS

This application claims benefit of U.S. Provisional Application No. 62/945,976 filed on Dec. 10, 2019, the disclosure of which is hereby incorporated by reference in its entirety for all purposes.

### BACKGROUND OF THE INVENTION

### 1. Field of the Invention

The present invention relates to an electric battery charging system in a motor vehicle.

### 2. Description of the Related Art

Current limitations in battery technology, vehicle battery capacity, and the power grid combine to limit the range of electric vehicles (EVs) and the rate at which they can be charged. Thus, most charging has to be performed overnight and at home, although some stations are available for “quick stop” charging.

Tesla had an idea for battery swapping using a special station that would remove the depleted battery robotically from underneath the vehicle and replace it with a charged battery.

### SUMMARY OF THE INVENTION

The invention may enable mobile autonomous electric vehicle (EV) charging. This wireless system enables charging from vehicle-to-vehicle while the vehicles are either in motion or stationary.

The invention may enable charging while the vehicle is on the move, enabling the range of the vehicle to be increased without any time being wasted. Charging when the inventive vehicle is parked is also possible. However, the inventive feature of charging while the vehicle is moving enables the vehicle to waste less time charging because the vehicle can be moving to its destination while charging, and the vehicle does not have to go out of its way to get to a traditional stationary charging station. Rather, the inventive vehicle can receive a charge from another vehicle without even having to slow down or pull off the road.

The invention may enable the vehicle driver to spend less time and money by using more local resources. With the proliferation of autonomous EVs, the inventive system could be especially useful in remote areas where stationary charging stations and people driving other EVs who could provide a charge are scarce.

In a first embodiment, the invention may enable mobile air charging between two vehicles. Each vehicle may be equipped with an inductive wireless charging receiver and an inductive wireless charging transmitter connected to a battery management system (BMS) which directs the power to/from the vehicle's battery. The driver of Vehicle A may use the vehicle infotainment system to create a request for charging. That request may be sent through cellular, satellite, vehicle to vehicle (V2V), or other communication methods to an app or to Vehicle B's in-vehicle infotainment (IVI) system. Users of the app or of Vehicle B may receive notifications through their mobile device or IVI system that a charge request was issued by a nearby Vehicle A. Once a manager of Vehicle B has accepted the charge request, the location of Vehicle A may be set as the destination of Vehicle B. Vehicle B may then travel to Vehicle A's location and trigger the charging system when the two vehicles are in close proximity. The two vehicles may then configure themselves for charging/discharging. When the two vehicles are within an acceptable distance of each other and have an acceptable orientation, the vehicle charging systems may start. The electric charge may be transmitted wirelessly through induction from Vehicle B to Vehicle A. Vehicle B's battery may discharge to charge Vehicle A's battery.

In a second embodiment, the invention may enable mobile docked charging between two vehicles. Each of the two vehicles may be equipped with physical mating connectors having an auto-locking mechanism or magnetic coupling connected to the battery management system (BMS) which directs the power to/from the vehicle's battery. The driver of Vehicle A may use the vehicle infotainment system to create a request for charging. That request may be sent through cellular, satellite, vehicle to vehicle (V2V), or other communication methods to an app or to Vehicle B's in-vehicle infotainment (IVI) system. Users of the app or of Vehicle B may receive notifications through their mobile device or IVI system that a charge request was issued by a nearby Vehicle A. Once a manager of Vehicle B has accepted the charge request, the location of Vehicle A may be set as the destination of Vehicle B. Vehicle B may then travel to Vehicle A's location and trigger the charging system when the two vehicles are in close proximity. The two vehicles may then physically configure themselves for charging/discharging. When the two vehicles are within an acceptable distance of each other and have an acceptable orientation, the vehicle charging systems may start. The electric charge may be transmitted through a wired system and the coupled connectors from Vehicle B to Vehicle A. Vehicle B's battery may discharge to charge Vehicle A's battery.

The connectors may include an electrically actuated cam-lock with quick disconnect capability or a magnetic coupling to reduce the number of moving parts and enable a faster disconnect. A fast disconnect may be needed in case of an emergency such as an accident, sudden acceleration, braking, swerving, etc.

In a first business case scenario, both Vehicle A and Vehicle B are privately owned vehicles. Each vehicle owner or vehicle account user may have their financial banking information stored in the app or IVI. Upon completion of the charge event, the monetary funds may be transferred from the Vehicle A owner to the Vehicle B owner.

In a second business case scenario, Vehicle A is privately owned and Vehicle B is a large commercial vehicle whose sole purpose is to charge autonomous EVs. The Vehicle A owner may would have their financial banking information stored in the app or IVI. Upon completion of the charge event, the monetary funds may be transferred from the Vehicle A owner to the Vehicle B company. Vehicle B in this case may be of a passenger vehicle size up to a semi-truck size.

The invention comprises, in one form thereof, an arrangement for charging a battery in a first motor vehicle. The arrangement includes a wireless charger receiver electrically coupled to the battery. The wireless charger receiver wirelessly receives electrical energy from a second motor vehicle and stores the received electrical energy in the battery. A battery management system is electrically connected to the wireless charger receiver and to the battery. The battery management system controls transfer of the electrical energy from the wireless charger receiver to the battery.

The invention comprises, in another form thereof, a method for charging a battery in a first motor vehicle, including electrically coupling a wireless charger receiver to the battery. Electrical energy is wirelessly received at the wireless charger receiver from a second motor vehicle. The wirelessly received electrical energy is stored in the battery.

The invention comprises, in yet another form thereof, a method for charging a battery in a first motor vehicle, including electrically coupling a wireless charger receiver to the battery. A request to receive a charge from a second motor vehicle is wirelessly transmitted from the first motor vehicle. Electrical energy is wirelessly received at the wireless charger receiver from the second motor vehicle while both the first motor vehicle and the second motor vehicle are drivingly rotating their tires to travel along a road. The wirelessly received electrical energy is stored in the battery.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic diagram of one embodiment of a vehicle charging arrangement of the present invention.

FIG. 2 is a block diagram of Vehicle B of FIG. 1.

FIG. 3 is a block diagram of Vehicle A of FIG. 1.

FIG. 4 is a schematic diagram of another embodiment of a vehicle charging arrangement of the present invention.

FIG. 5 is a block diagram of the vehicle charging arrangement of FIG. 4.

FIG. 6 is a flow chart of one embodiment of a method of the present invention for charging a battery in a first motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

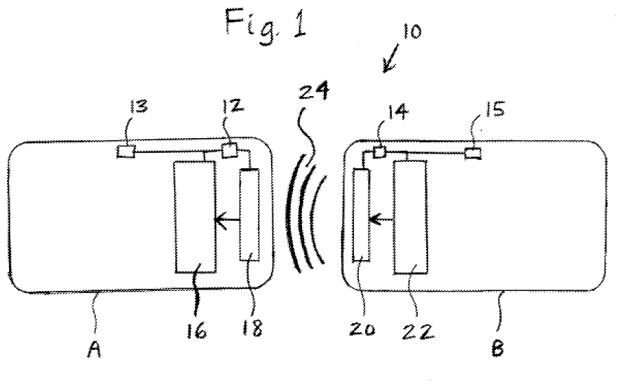

FIG. 1 illustrates one embodiment of a vehicle charging arrangement 10 of the present invention including Vehicle A and Vehicle B for mobile air charging. Vehicle A includes a battery management system (BMS) 12, an infotainment system 13, a high voltage battery pack 16, and a wireless charger receiver 18. Vehicle B includes a BMS 14, an infotainment system 15, a wireless charger transmitter 20, and a high voltage battery pack 22.

During use, BMS 12 may direct the electrical power to battery pack 16, and BMS 14 may direct the electrical power from battery pack 22. The driver of Vehicle A may use vehicle infotainment system 13 to create a request for charging. That request may be sent through cellular, satellite, vehicle to vehicle (V2V), or other communication methods to an app or to Vehicle B's in-vehicle infotainment (IVI) system 15. Users of the app or of Vehicle B may receive notifications through their mobile device or IVI system 15 that a charge request was issued by a nearby Vehicle A. Once a manager of Vehicle B has accepted the charge request, the location of Vehicle A may be set as the destination of Vehicle B in the navigation system of Vehicle B. Vehicle B may then travel to Vehicle A's location and trigger BMS 12 and/or BMS 14 when the two vehicles A, B are in close proximity such that the inductive transfer of electrical energy may be of at least a threshold efficiency. The two vehicles A, B may then configure themselves for charging/discharging. When the two vehicles are within an acceptable distance of each other and have an acceptable orientation, the vehicle charging systems may start. The electric charge may be transmitted wirelessly through induction from Vehicle B to Vehicle A, as indicated at 24. For example, wireless charger transmitter 20 may create an electric field through which electrical current may be transferred from Vehicle B's battery pack 22 to charge Vehicle A's battery pack 16.

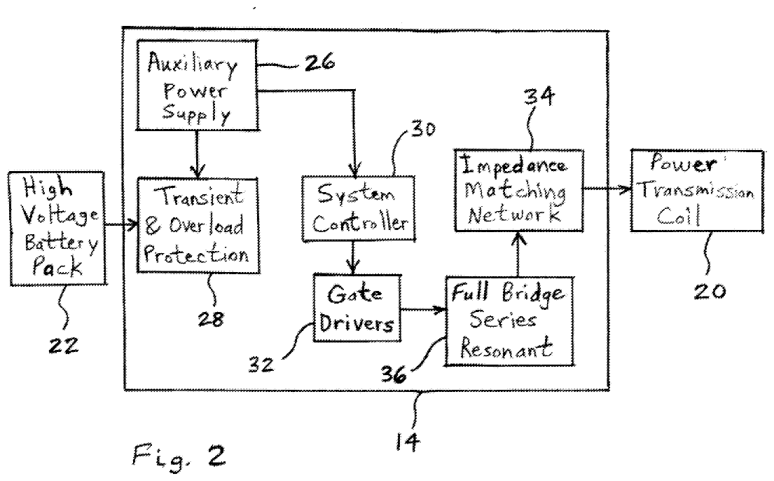

FIG. 2 illustrates Vehicle B of FIG. 1 in greater detail. BMS 14 includes an auxiliary power supply 26, a transient and overload protection block 28, a system controller 30, gate drivers 32, an impedance matching network 34, and a full bridge series resonant block 36.

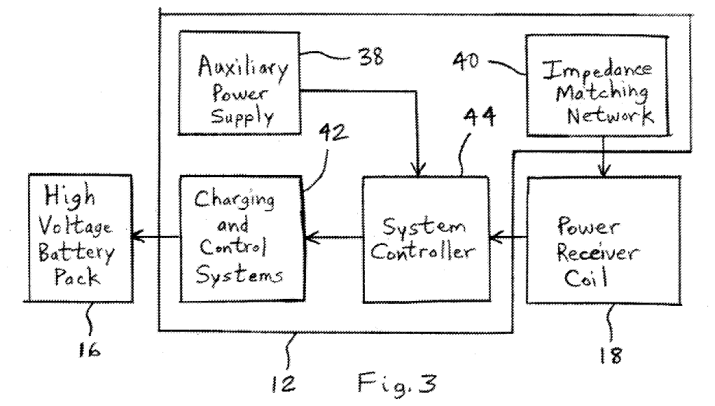

FIG. 3 illustrates Vehicle A of FIG. 1 in greater detail. BMS 12 includes an auxiliary power supply 38, an impedance matching network 40, charging and control systems 42, and a system controller 44.

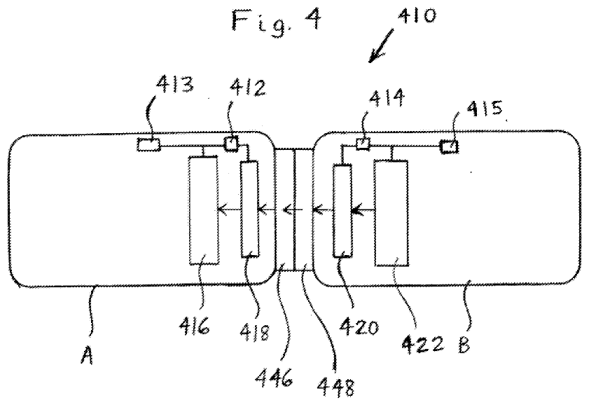

FIG. 4 illustrates another embodiment of a vehicle charging arrangement 410 of the present invention including Vehicle A and Vehicle B for mobile docked charging. Vehicle A includes a battery management system (BMS) 412, an infotainment system 413, a high voltage battery pack 416, a charger receiver 418, and a high current connector plug 446. Vehicle B includes a BMS 414, an infotainment system 415, a charger transmitter 420, a high voltage battery pack 422, and a high current connector plug 448. High current connector plugs 446, 448 may be physical mating connectors having an auto-locking mechanism or magnetic coupling connected to the respective battery management system (BMS) 412, 414.

During use, BMS 412 may direct the electrical power to battery pack 416, and BMS 414 may direct the electrical power from battery pack 422. The driver of Vehicle A may use vehicle infotainment system 413 to create a request for charging. That request may be sent through cellular, satellite, vehicle to vehicle (V2V), or other communication methods to an app or to Vehicle B's in-vehicle infotainment (IVI) system 415. Users of the app or of Vehicle B may receive notifications through their mobile device or IVI system 415 that a charge request was issued by a nearby Vehicle A. Once a manager of Vehicle B has accepted the charge request, the location of Vehicle A may be set as the destination of Vehicle B in the navigation system of Vehicle B. Vehicle B may then travel to Vehicle A's location and trigger BMS 412 and/or BMS 414 when the two vehicles A, B are in close proximity and high current connector plugs 446, 448 have been coupled together. The two vehicles A, B may then configure themselves for charging/discharging. When the two vehicles are within an acceptable distance of each other and have an acceptable orientation, high current connector plugs 446, 448 may be coupled together and the vehicle charging systems may start. The electric charge may be transmitted through the electrical conductors of connector plugs 446, 448 from Vehicle B to Vehicle A to charge Vehicle A's battery pack 416.

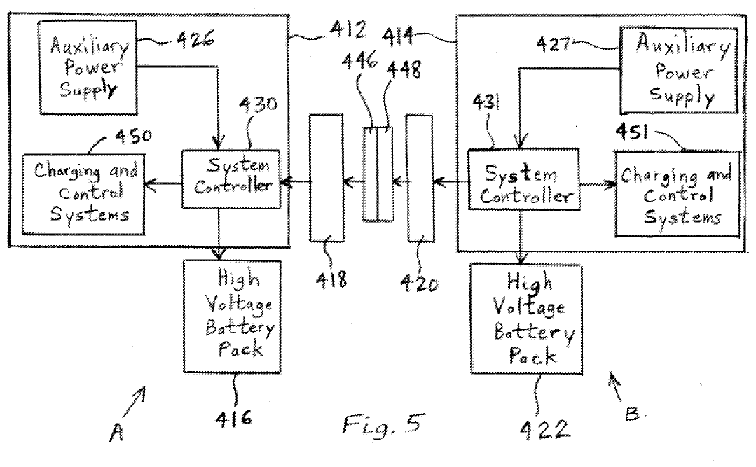

FIG. 5 is a block diagram of the vehicle charging arrangement 410 of FIG. 4. BMS 412 includes an auxiliary power supply 426, a system controller 430, and charging and control systems 450. BMS 414 includes an auxiliary power supply 427, a system controller 431, and charging and control systems 451.

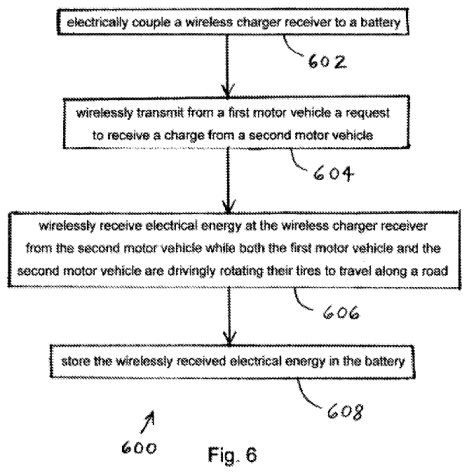

FIG. 6 illustrates one embodiment of a method 600 of the present invention for charging a battery in a first motor vehicle. In a first step 602, a wireless charger receiver is electrically coupled to the battery. For example, wireless charger receiver 18 may be electrically coupled to battery pack 16.

Next, in step 604, a request to receive a charge from a second motor vehicle is wirelessly transmitted from the first motor vehicle. For example, the driver of Vehicle A may use vehicle infotainment system 13 to create a request for charging. That request may be sent through cellular, satellite, vehicle to vehicle (V2V), or other communication methods to an app or to Vehicle B's in-vehicle infotainment (IVI) system 15.

In a next step 606, electrical energy is wirelessly received at the wireless charger receiver from the second motor vehicle while both the first motor vehicle and the second motor vehicle are drivingly rotating their tires to travel along a road. For example, the electric charge may be transmitted wirelessly through induction from Vehicle B to Vehicle A, as indicated at 24. Wireless charger transmitter 20 may create an electric field through which electrical current may be transferred to wireless charger receiver 18. The charging may occur while both Vehicle A and Vehicle B are traveling along a road, perhaps side-by-side or one vehicle behind the other.

In a final step 608, the wirelessly received electrical energy is stored in the battery. For example, the electrical current received by wireless charger receiver 18 may be used to charge Vehicle A's battery pack 16 and thereby store the electrical energy in battery pack 16.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An arrangement for charging a battery in a first motor vehicle, the arrangement comprising:
a wireless charger receiver configured to:
be electrically coupled to the battery;
wirelessly receive electrical energy from a second motor vehicle; and
store the received electrical energy in the battery; and
a battery management system electrically connected to the wireless charger receiver and to the battery, the battery management system being configured to control transfer of the electrical energy from the wireless charger receiver to the battery.

2. The arrangement of claim 1, wherein the wireless charger receiver includes a power receiver coil.

3. The arrangement of claim 2, wherein the battery management system includes an impedance matching network.

4. The arrangement of claim 1, wherein the wireless charger receiver is configured to inductively receive the electrical energy from the second motor vehicle.

5. The arrangement of claim 1, wherein the battery is included in a high voltage battery pack.

6. The arrangement of claim 1, further comprising a vehicle infotainment system coupled to the battery management system.

7. The arrangement of claim 6, wherein the vehicle infotainment system is configured to create a request to the second motor vehicle for charging.

8. A method for charging a battery in a first motor vehicle, the method comprising:
electrically coupling a wireless charger receiver to the battery;
wirelessly receiving electrical energy at the wireless charger receiver from a second motor vehicle; and
storing the wirelessly received electrical energy in the battery.

9. The method of claim 8 wherein the wireless charger receiver includes a power receiver coil.

10. The method of claim 9, further comprising electrically coupling an impedance matching network to the power receiver coil.

11. The method of claim 8, wherein the electrical energy is inductively received from the second motor vehicle.

12. The method of claim 8, wherein the battery is included in a high voltage battery pack.

13. The method of claim 8, further comprising wirelessly transmitting a request to the second motor vehicle for charging.

14. The method of claim 8, further comprising wirelessly transmitting an initiation of a transfer of monetary funds to an owner of the second motor vehicle in response to the wireless receiving of the electrical energy from the second motor vehicle.

15. A method for charging a battery in a first motor vehicle, the method comprising:
electrically coupling a wireless charger receiver to the battery;
wirelessly transmitting from the first motor vehicle a request to receive a charge from a second motor vehicle;
wirelessly receiving electrical energy at the wireless charger receiver from the second motor vehicle while both the first motor vehicle and the second motor vehicle are drivingly rotating their tires to travel along a road; and
storing the wirelessly received electrical energy in the battery.

16. The method of claim 15 wherein the wireless charger receiver includes a power receiver coil.

17. The method of claim 16, further comprising electrically coupling an impedance matching network to the power receiver coil.

18. The method of claim 15, wherein the electrical energy is inductively received from the second motor vehicle.

19. The method of claim 15, wherein the battery is included in a high voltage battery pack.

20. The method of claim 15, further comprising wirelessly transmitting an initiation of a transfer of monetary funds to an owner of the second motor vehicle in response to the wireless receiving of the electrical energy from the second motor vehicle.
